(19) United States
(12) Patent Application Publication
(10) Pub. No.: US 2015/0086794 A1
(43) Pub. Date: Mar. 26, 2015

(54) GLASS LAMINATE AND METHOD FOR MANUFACTURING ELECTRONIC DEVICE

(71) Applicant: Asahi Glass Company, Limited, Chiyoda-ku (JP)

(72) Inventors: Yosuke AKITA, Tokyo (JP); Yoshitaka MATSUYAMA, Tokyo (JP); Kenichi EBATA, Tokyo (JP); Daisuke UCHIDA, Tokyo (JP)

(73) Assignee: Asahi Glass Company, Limited, Chiyoda-ku (JP)

(21) Appl. No.: 14/555,936

(22) Filed: Nov. 28, 2014

Related U.S. Application Data
(63) Continuation of application No. PCT/JP2013/063312, filed on May 13, 2013.

(30) Foreign Application Priority Data
May 29, 2012 (JP) 2012-122492

(51) Int. Cl. B32B 17/06; B32B 9/00

(52) U.S. Cl. CPC B32B 17/06; B32B 9/00; B32B 2250/02; B32B 2315/08; B32B 2315/02; B32B 2457/20
USPC 428/427; 428/426; 428/428; 428/432; 156/247

(57) ABSTRACT

The present invention has an object to provide a glass laminate in which a glass substrate can be easily peeled even after a long-time treatment under high temperature conditions. The present invention relates to a glass laminate including: an inorganic layer-attached supporting substrate including a supporting substrate and an inorganic layer containing at least one kind selected from the group consisting of a metal silicide, a nitride, a carbide and a carbonitride, arranged on the supporting substrate; and a glass substrate peelably laminated on the inorganic layer.

### TECHNICAL FIELD

The present invention relates to a glass laminate that is a laminate of a glass substrate and supporting substrate, used in manufacturing an electronic device such as a liquid crystal display, an organic EL display or the like using a glass substrate, and a method for manufacturing an electronic device using the same.

### BACKGROUND ART

In recent years, reduction in thickness and weight of an electronic device (electronic equipment) such as solar cells (PV), liquid crystal panels (LCD) or organic EL panels (OLED) is advanced, and reduction in thickness of a glass substrate used in those electronic devices is advanced. On the other hand, in the case where strength of a glass substrate is insufficient due to the reduction in thickness, handling property of a glass substrate is deteriorated in a manufacturing process of an electronic device.

In view of the above, to respond to the above problem, a method in which a laminate obtained by laminating a glass substrate on an inorganic thin film of an inorganic thin film-attached supporting glass is prepared, a manufacturing treatment of an element is conducted on the glass substrate of the laminate, and the glass substrate is then separated from the laminate has been proposed recently (Patent Document 1). It is disclosed that according to this method, handling property of a glass substrate is improved, appropriate positioning becomes possible, and additionally a glass substrate having an element arranged thereon can be easily peeled from a laminate after a predetermined treatment.

### BACKGROUND ART DOCUMENT

### Patent Document

Patent Document 1: JP-A-2011-184284

### SUMMARY OF THE INVENTION

### Problems that the Invention is to Solve

On the other hand, in recent years, with the requirement of high performance of an electronic device, it is desired that a treatment under higher temperature conditions (for example, 350° C. or higher) is carried out in production of an electronic device.

When the present inventors carried out a heat treatment under high temperature conditions (for example, 350° C. and 1 hour) using a laminate in which a glass substrate is arranged on the inorganic thin film of the inorganic thin film-attached supporting glass constituted of a metal oxide specifically described in Patent Document 1, the glass substrate could not be peeled from the laminate after the treatment. This embodiment gives rise to a problem that a glass substrate having an element formed thereon cannot be peeled from a laminate after production of a device under high temperature conditions.

The present invention has been made in view of the above problems, and has an object to provide a glass laminate in which a glass substrate can be easily peeled even after a long-time treatment under high temperature conditions, and a method for manufacturing an electronic device using the glass laminate.

### Means for Solving the Problems

As a result of earnest investigation to solve the above problems, the present inventors have found that the above problems can be solved by forming an inorganic layer having predetermined components on a glass substrate, and have reached to complete the present invention.

Namely, a first embodiment of the present invention is a glass laminate comprising: an inorganic layer-attached supporting substrate comprising a supporting substrate and an inorganic layer containing at least one kind selected from the group consisting of a metal silicide, a nitride, a carbide and a carbonitride, arranged on the supporting substrate; and a glass substrate peelably laminated on the inorganic layer.

In the first embodiment, it is preferable that: the metal silicide contains at least one kind selected from the group consisting of W, Fe, Mn, Mg, Mo, Cr, Ru, Re, Co, Ni, Ta, Ti, Zr and Ba; the nitride contains at least one element selected from the group consisting of Si, Hf, Zr, Ta, Ti, Nb, Na, Co, Al, Zn, Pb, Mg, Sn, In, B, Cr, Mo and Ba; and the carbide and carbonitride contain at least one element selected from the group consisting of Ti, W, Si, Zr and Nb.

In the first embodiment, it is preferable that the inorganic layer contains at least one kind selected from the group consisting of tungsten silicide, aluminum nitride, titanium nitride, silicon nitride and silicon carbide.

In the first embodiment, it is preferable that the inorganic layer contains silicon nitride and/or silicon carbide.

In the first embodiment, it is preferable that the supporting substrate is a glass substrate.

In the first embodiment, it is preferable that the inorganic layer-attached supporting substrate and the glass substrate are peelable to each other even after heat-treating at 600° C. for 1 hour.

Additionally, a second embodiment of the present invention is a method for manufacturing an electronic device, the method comprising:

a member formation step of forming an electronic device member on a surface of the glass substrate in the glass laminate according to the first embodiment to obtain an electronic device member-attached laminate; and

a separation step of peeling the inorganic layer-attached supporting substrate from the electronic device member-attached laminate to obtain an electronic device having the glass substrate and the electronic device member.

### Advantage of the Invention

According to the present invention, a glass laminate in which a glass substrate can be easily peeled even after a long-time treatment under high temperature conditions, and a method for manufacturing an electronic device using the glass laminate can be provided.

### BRIEF DESCRIPTION OF THE DRAWINGS

FIG. 1 is a schematically cross-sectional view of one embodiment of a glass laminate according to the present invention.

FIGS. 2A and 2B are process charts of a method for manufacturing an electronic device according to the present invention.

### MODE FOR CARRYING OUT THE INVENTION

Preferred embodiments of a glass laminate and a method for manufacturing an electronic device of the present invention are described below by reference to the drawings, but the invention is not construed as being limited to embodiments described below, and can add various changes and modifications to the embodiments described below without departing the scope of the present invention.

One of the characteristics in the glass laminate of the present invention is that an inorganic layer containing at least one kind selected from the group consisting of a metal silicide, a nitride, a carbide and a carbonitride is interposed between a supporting substrate and a glass substrate. When an inorganic layer having predetermined components is interposed, adhesion of the glass substrate to the supporting substrate under high temperature conditions can be suppressed, and the glass substrate can be easily peeled after a predetermined treatment. Particularly, in those inorganic layers, an amount of a hydroxyl group or the like on the surface thereof is small, and a chemical bond becomes difficult to be formed between the inorganic layer and the glass substrate formed thereon even in a heat treatment. As a result, it is presumed that those can be easily peeled to each other even after high temperature treatment. On the other hand, since many hydroxyl groups are present on a layer surface of a metal oxide specifically described in Patent Document 1, many chemical bonds are formed between the layer surface and a glass substrate at a heat treatment, and it is presumed that peelability of the glass substrate is deteriorated.

In the following description, a preferred embodiment of the glass laminate is first described in detail, and thereafter, a preferred embodiment of a method for manufacturing an electronic device using the glass laminate is described in detail.

### <Glass Laminate>

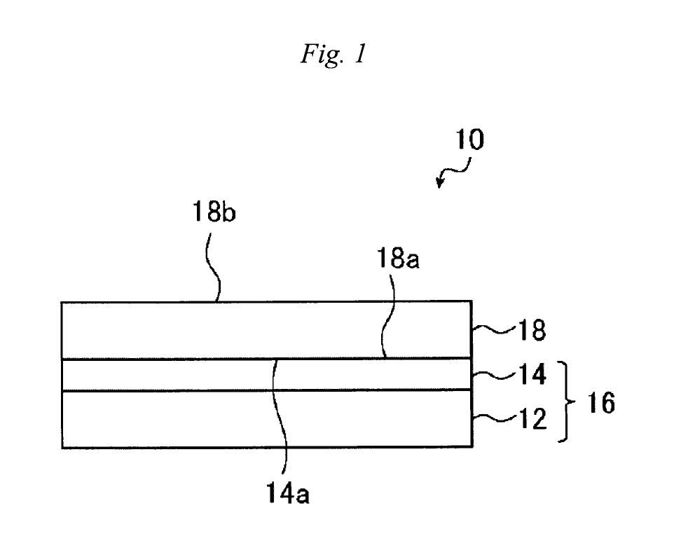

FIG. 1 is a schematically cross-sectional view of one embodiment of the glass laminate according to the present invention.

As shown in FIG. 1, a glass laminate 10 has an inorganic layer-attached supporting substrate 16 comprising a supporting substrate 12 and an inorganic layer 14, and a glass substrate 18. In the glass laminate 10, the inorganic layer-attached supporting substrate 16 and the glass substrate 18 are peelably laminated such that a first main surface 14a of the inorganic layer 14 (a surface opposite a supporting substrate 12 side) of the inorganic layer-attached supporting substrate 16 and a first main surface 18a of the glass layer 18 are lamination surfaces. Specifically, the inorganic layer 14 is that one surface thereof is fixed to a layer of the supporting substrate 12, the other surface thereof is brought into contact with the first main surface 18a of the glass substrate 18, and the interface between the inorganic layer 14 and the glass substrate 18 is peelably closely adhered. In other words, the inorganic layer 14 has easy peelability to the first main surface 18a of the glass substrate 18.

Furthermore, the glass laminate 10 is used until a member formation step described hereinafter. That is, the glass laminate 10 is used until an electronic device member such as a liquid crystal display is formed on a second main surface 18b of the glass substrate 18. Thereafter, a layer of the inorganic layer-attached supporting substrate 16 is peeled at the interface to a layer of the glass substrate 18, and the layer of the inorganic layer-attached supporting substrate 16 does not constitute a member constituting an electronic device. The inorganic layer-attached supporting substrate 16 separated is laminated on a fresh glass substrate 18, and the resulting laminate can be recycled as a fresh glass laminate 10.

In the present invention, the above-mentioned “fixing” differs from “(peelable) close adhesion” in peel strength (that is, stress required for peeling), and the “fixing” means that peel strength is large as compared with close adhesion. Specifically, peel strength of the interface between the inorganic layer 14 and the supporting substrate 12 is larger than peel strength of the interface between the inorganic layer 14 and the glass substrate 18 in the glass laminate 10.

Furthermore, the “peelable close adhesion” means that peeling is possible, and simultaneously, peeling is possible without causing peeling of a surface fixed. That is, in the case where an operation of separating the glass substrate 18 from the supporting substrate 12 has been conducted in the glass laminate 10 of the present invention, peeling occurs at the closely adhered surface (the interface between the inorganic layer 14 and the glass substrate 18), and peeling does not occur at the fixed surface. Therefore, when an operation that the glass laminate 10 is separated into the glass substrate 18 and the supporting substrate 12 is conducted, the glass laminate 10 is separated into two parts of the glass substrate 18 and the inorganic layer-attached supporting substrate 16.

In the following description, the inorganic layer-attached supporting substrate 16 and the glass substrate 18, that constitute the glass laminate 10 are first described in detail, and the procedure of the manufacture of the glass laminate 10 is then described in detail.

### [Inorganic Layer-Attached Supporting Substrate]

The inorganic layer-attached supporting substrate 16 comprises the supporting substrate 12 and the inorganic layer 14 arranged (fixed) on the surface thereof. The inorganic layer 14 is arranged at an outermost side in the inorganic layer-attached supporting substrate 16 so as to peelably closely adhere to the glass substrate 18 described hereinafter.

The embodiments of the supporting substrate 12 and the inorganic layer 14 are described in detail below.

### (Supporting Substrate)

The supporting substrate 12 has a first main surface and a second main surface, and is a substrate that supports and reinforces the glass substrate 18 by cooperating with the inorganic layer 14 arranged on the first main surface, and prevents deformation, scratches, breakage and the like of the glass substrate 18 when manufacturing an electronic device member in a member formation step (a step for manufacturing an electronic device member) described hereinafter.

For example, a glass plate, a plastic plate, a metal plate such as SUS plate, or the like is used as the supporting substrate 12. In the case where the member formation step accompanies the heat treatment, the supporting substrate 12 is preferably formed by a material having small difference in a linear expansion coefficient to the glass substrate 18, and more preferably formed by the same material as the glass substrate 18. The supporting substrate 12 is preferably a glass plate. The supporting substrate 12 is particularly preferably a glass plate comprising the same glass material as the glass substrate 18.

The thickness of the supporting substrate 12 may be larger than and may be smaller than that of the glass substrate 18 described hereinafter. Preferably, the thickness of the supporting substrate 12 is selected on the basis of the thickness of the glass substrate 18, the thickness of the inorganic layer 14 and the thickness of the glass laminate 10 described hereinafter. For example, in the case where the current member formation step is designed so as to treat a substrate having a thickness of 0.5 mm and the sum of the thickness of the glass substrate 18 and the thickness of the inorganic layer 14 is 0.1 mm, the thickness of the supporting substrate 12 is 0.4 mm. The thickness of the supporting substrate 12 is preferably from 0.2 to 5.0 mm in the usual case.

In the case where the supporting substrate 12 is a glass plate, the thickness of the glass plate is preferably 0.08 mm or more for the reasons that such a glass plate is easy to handle and is difficult to break. Furthermore, the thickness of the glass plate is preferably 1.0 mm or less for the reason that rigidity in which the glass plate does not break and moderately warps when peeling after the formation of an electronic device member is desired.

The difference in an average linear expansion coefficient in a range of from 25 to 300° C. between the supporting substrate 12 and the glass substrate 18 (hereinafter simply referred to as an “average linear expansion coefficient”) is preferably 500×10⁻⁷/° C. or less, more preferably 300×10⁻⁷/° C. or less, and still more preferably 200×10⁻⁷/° C. or less. In the case where the difference is too large, there is a concern that the glass laminate 10 violently warps when heating and cooling in a member formation step. In the case where the material of the glass substrate 18 and the material of the supporting substrate 12 are the same, the case can suppress occurrence of such a problem.

### (Inorganic Layer)

The inorganic layer 14 is a layer that is arranged (fixed) on the main surface of the supporting substrate 12 and comes into contact with a first main surface 18a of the glass substrate 18. By providing the inorganic layer 14 on the supporting substrate 12, adhesion of the glass substrate 18 can be suppressed even after a long-time treatment under high temperature conditions.

The inorganic layer 14 contains at least one kind selected from the group consisting of a metal silicide, a nitride, a carbide and a carbonitride. Above all, it is preferred to contain at least one kind selected from the group consisting of tungsten silicide, aluminum nitride, titanium nitride, silicon nitride and silicon carbide in that peelability of the glass substrate 18 to the inorganic layer 14 is further excellent. Above all, it is more preferred to contain silicon nitride and/or silicon carbide. The reason that the above components are preferred is presumed to be due to a largeness of difference in electronegativity between Si, N or C contained in the metal silicide, the nitride, the carbide and the carbonitride and an element to be combined with those elements. In the case where the difference in electronegativity is small, polarization is small, and a hydroxyl group is difficult to be formed by a reaction with water. As a result, peelability of the glass substrate to the inorganic layer 14 becomes better. More specifically, in SiN, the difference in electronegativity between Si element and N element is 1.14; in AlN, the difference in electronegativity between Al element and N element is 1.43; and in TiN, the difference in electronegativity between Ti element and N element is 1.50. Comparing the three, SiN has the smallest difference in electronegativity, and peelability of the glass substrate 18 to the inorganic layer 14 is further excellent.

The inorganic layer 14 may contain two or more of the above components.

The composition of the metal silicide is not particularly limited, but it is preferred to contain at least one kind selected from the group consisting of W, Fe, Mn, Mg, Mo, Cr, Ru, Re, Co, Ni, Ta, Ti, Zr and Ba in that peelability of the glass substrate 18 is further excellent. Furthermore, by changing the metal/silicon element ratio, the number of OH groups on the surface of the inorganic layer 14 and surface flatness of the inorganic layer 14 are adjusted, whereby close adhesion force between the inorganic layer 14 and the glass substrate 18 can be controlled.

Furthermore, the composition of the nitride is not particularly limited, but it is preferred to contain at least one element selected from the group consisting of Si, Hf, Zr, Ta, Ti, Nb, Na, Co, Al, Zn, Pb, Mg, Sn, In, B, Cr, Mo and Ba in that peelability of the glass substrate 18 is further excellent. Furthermore, by changing the metal/nitrogen element ratio, the number of OH groups on the surface of the inorganic layer 14 and surface flatness of the inorganic layer 14 are adjusted, whereby close adhesion force between the inorganic layer 14 and the glass substrate 18 can be controlled.

Furthermore, the composition of the carbide and the carbonitride is not particularly limited, but it is preferred to contain at least one element selected from the group consisting of Ti, W, Si, Zr and Nb in that peelability of the glass substrate 18 is further excellent. Furthermore, by changing the metal/carbon element ratio, the number of OH groups on the surface of the inorganic layer 14 and surface flatness of the inorganic layer 14 are adjusted, whereby close adhesion force between the inorganic layer 14 and the glass substrate 18 can be controlled.

Furthermore, a part of the inorganic layer 14 may be oxidized. In other words, an oxygen atom (oxygen element) (O) may be contained in the inorganic layer 14.

In the metal silicide, nitride, carbide and carbonitride, by the addition amount of an oxygen atom, the number of OH groups on the surface of the inorganic layer 14 and surface flatness of the inorganic layer 14 are adjusted, whereby close adhesion force between the inorganic layer 14 and the glass substrate 18 can be controlled.

More specifically, examples of the metal silicide include WSi, FeSi, MnSi, MgSi, MoSi, CrSi, RuSi, ReSi, CoSi, NiSi, TaSi, TiSi, ZrSi and BaSi.

Examples of the nitride include SiN, TIN, WN, CrN, BN, MoN, AlN and ZrN.

Examples of the carbide include TiC, WC, SiC, NbC and ZrC.

Examples of the carbonitride include TiCN, WCN, SiCN, NbCN and ZrCN.

The average linear expansion coefficient of the inorganic layer 14 is not particularly limited, but in the case where a glass plate is used as the supporting substrate 12, the average linear expansion coefficient thereof is preferably from 10×10⁻⁷ to 200×10⁻⁷/° C. When it is within the range, the difference in the average linear expansion coefficient to the glass plate (SiO₂) is small, and position deviation between the glass substrate 18 and the inorganic layer-attached supporting substrate 16 in high temperature environment can be further suppressed.

It is preferred that the inorganic layer 14 contains at least one kind selected from the group consisting of the above-described metal silicide, nitride, carbide and carbonitride as a main component. The term “main component” used herein means that the total content of those components is 90 mass % or more based on the total amount of the inorganic layer 14. The total content thereof is preferably 98 mass % or more, more preferably 99 mass % or more, and particularly preferably 99.999 mass % or more.

The thickness of the inorganic layer 14 is not particularly limited, but is preferably from 5 to 5,000 nm, and more preferably from 10 to 500 nm, in that scratch resistance is maintained.

The inorganic layer 14 is shown as a single layer in FIG. 1, but may be a lamination layer of two layers or more. In the case of the lamination layer of two layers or more, each layer may have a different composition.

The inorganic layer 14 is generally provided on the entire surface of one main surface of the supporting substrate 12 as shown in FIG. 1, but may be provided on a part of the surface of the supporting substrate 12 in a range that does not impair the advantageous effect of the present invention. For example, the inorganic layer 14 may be provided in an island shape or a stripe shape on the surface of the supporting substrate 12.

Furthermore, the surface roughness (Ra) of a face of the inorganic layer 14 contacting the glass substrate 18 (that is, the first main surface 14a of the inorganic layer 14) is preferably 2.0 nm or less, and more preferably 1.0 nm or less. The lower limit is not particularly limited, but 0 is most preferred. When the surface roughness thereof falls within the above range, close adhesiveness to the glass substrate 18 becomes good, and position deviation of the glass substrate 18 can be further suppressed, and additionally, peelability of the glass substrate 18 is excellent.

Ra is measured according to JIS B 0601 (the 2001 revision).

The inorganic layer 14 shows excellent heat resistance. For this reason, even though the glass laminate 10 is exposed to high temperature conditions, chemical change of the layer itself is difficult to occur, chemical bond is difficult to be formed between the inorganic layer 14 and the glass substrate 18 described hereinafter, and adhesion of the glass substrate 18 to the inorganic layer 14 by heavy peeling is difficult to occur.

The above-described “heavy peeling” means that peel strength of the interface between the inorganic layer 14 and the glass substrate 18 is larger than any of peel strength of the interface between the supporting substrate 12 and the inorganic layer 14 and strength (bulk strength) of the material itself of the inorganic layer 14. In the case where the heavy peeling occurs in the interface between the inorganic layer 14 and the glass substrate 18, the component of the inorganic layer 14 is easy to adhere to the surface of the glass substrate 18, and cleaning of the surface is apt to become difficult. The adhesion of the inorganic layer 14 to the surface of the glass substrate 18 means that the entire inorganic layer 14 adheres to the surface of the glass substrate 18, the surface of the inorganic layer 14 is damaged and a part of the component of the inorganic layer 14 adheres to the surface of the glass substrate 18, and the like.

### [Method for Manufacturing Inorganic Layer-Attached Supporting Substrate]

A method for manufacturing the inorganic layer-attached supporting substrate 16 is not particularly limited, and the conventional methods can be used. For example, a method of providing the inorganic layer 14 comprising a predetermined component on the supporting substrate 12 by a deposition method, a sputtering method or a CVD method is exemplified.

Regarding manufacturing conditions, optimum conditions are appropriately selected depending on materials used.

As necessary, a treatment of grinding the surface of the inorganic layer 14 may be applied in order to control surface property (for example, surface roughness Ra) of the inorganic layer 14 formed on the supporting substrate 12. For example, an ion sputtering method is exemplified as the treatment.

### [Glass Substrate]

The glass substrate 18 is that the first main surface 18a closely adheres to the inorganic layer 14 and an electronic device member described hereinafter is provided on the second main surface 18b at a side opposite a side of the inorganic layer 14.

The kind of the glass substrate 18 may be a general kind, and for example, a glass substrate for a display device such as LCD or OLED is exemplified. The glass substrate 18 has excellent chemical resistance and resistance to moisture permeability, and has low heat shrinkability. A linear expansion coefficient defined in JIS R 3102 (the 1995 revision) is used as an index of the heat shrinkability.

The glass substrate 18 is obtained by melting glass raw materials and forming the molten glass into a sheet shape. The forming method may be a general method, and for example, a float process, a fusion process, a slot down draw process, a Fourcault process and a Lubbers process are used. Furthermore, a particularly thin glass substrate is obtained by forming using a process (redraw process) of heating a glass once formed into a sheet shape to a formable temperature, and drawing the glass by the means such as stretching to reduce the thickness.

The glass of the glass substrate 18 is not particularly limited, but is preferably an alkali-free borosilicate glass, a borosilicate glass, a soda lime glass, a high silica glass and an oxide-based glass comprising other silicon oxide as a main component. The oxide-based glass is preferably a glass having a silicon oxide content of from 40 to 90 mass % in terms of an oxide.

A glass suitable for the kind of a device and its manufacturing process is used as the glass of the glass substrate 18. For example, with regard to a glass substrate for a liquid crystal panel, since elusion of an alkali metal component is apt to affect a liquid crystal, the glass substrate comprises a glass that does not substantially contain an alkali metal component (alkali-free glass) (provided that an alkaline earth metal component is generally contained). Thus, the glass of the glass substrate 18 is appropriately selected based on the kind of a device applied and its manufacturing process.

The thickness of the glass substrate 18 is not particularly limited, but from the standpoints of reduction in thickness and/or reduction in weight of the glass substrate 18, the thickness thereof is generally 0.8 mm or less, preferably 0.3 mm or less, and still more preferably 0.15 mm or less. In the case where the thickness thereof exceeds 0.8 mm, the requirement of reduction in thickness and/or reduction in weight of the glass substrate 18 is not satisfied. When the thickness thereof is 0.3 mm or less, good flexibility can be given to the glass substrate 18. When the thickness is 0.15 mm or less, the glass substrate 18 can be wound in a roll form. Furthermore, the thickness of the glass substrate 18 is preferably 0.03 mm or more for the reasons that a manufacture of the glass substrate 18 is easy, handling of the glass substrate 18 is easy, and the like.

The glass substrate 18 may comprise two layers or more. In this case, the material forming each layer may be the same kind of a material and may be a different kind of a material. Furthermore, in this case, the “thickness of a glass substrate” means the total thickness of all of layers.

An inorganic thin film layer may be further laminated on the first main surface 18a of the glass substrate 18.

When the inorganic thin film layer is arranged (fixed) on the glass substrate 18, the inorganic layer 14 of the inorganic layer-attached supporting substrate 16 comes into contact with the inorganic thin film layer in the glass laminate. When the inorganic thin film layer is provided on the glass substrate 18, adhesion between the glass substrate 18 and the inorganic layer-attached supporting substrate 16 can be further suppressed even after a long-time treatment under high temperature conditions.

The embodiment of the inorganic thin film layer is not particularly limited, but the inorganic thin film layer preferably contains at least one selected from the group consisting of a metal oxide, a metal nitride, a metal oxynitride, a metal carbide, a metal carbonitride, a metal silicide and a metal fluoride. Above all, it is preferred to contain a metal oxide in that peelability of the glass substrate 18 is further excellent. Above all, indium tin oxide is more preferred.

Examples of the metal oxide, metal nitride and metal oxynitride include oxides, nitrides and oxynitrides of at least one element selected from Si, Hf, Zr, Ta, Ti, Y, Nb, Na, Co, Al, Zn, Pb, Mg, Bi, La, Ce, Pr, Sm, Eu, Gd, Dy, Er, Sr, Sn, In and Ba. More specifically, titanium oxide (TiO₂), indium oxide (In₂O₃), tin oxide (SnO₂), zinc oxide (ZnO), gallium oxide (Ga₂O₃), indium tin oxide (ITO), indium zinc oxide (IZO), zinc tin oxide (ZTO), gallium-doped zinc oxide (GZO), and the like are exemplified.

Examples of the metal carbide and metal carbonitride include carbides and carbonitrides of at least one element selected from Ti, W, Si, Zr and Nb. Examples of the metal silicide include silicides of at least one element selected from Mo, W and Cr. Examples of the metal fluoride include fluorides of at least one element selected from Mg, Y, La and Ba.

### <Glass Substrate and Manufacturing Method Thereof>

The glass laminate 10 of the present invention is a laminate of the inorganic layer-attached supporting substrate 16 and the glass substrate 18 that are peelably laminated such that the first main surface 14a of the inorganic layer 14 in the inorganic layer-attached supporting substrate 16 described above and the first main surface 18a of the glass substrate 18 are lamination planes. In other words, it is a laminate in which the inorganic layer 14 is interposed between the supporting substrate 12 and the glass substrate 18.

The manufacturing method of the glass laminate 10 of the present invention is not particularly limited, but specifically, a method of stacking the inorganic layer-attached supporting substrate 16 and the glass substrate 18 in an ordinary pressure environment, and then press-bonding the resulting laminate using rolls or a press is exemplified. The inorganic layer-attached supporting substrate 16 and the glass substrate 18 are further closely adhered by press-bonding with rolls or a press, and this is preferred. Furthermore, gas bubbles present between the inorganic layer-attached supporting substrate 16 and the glass substrate 18 are relatively easily removed by press-bonding with rolls or a press, and this is preferred.

When press-bonding is conducted by a vacuum lamination method or a vacuum press method, suppression of incorporation of gas bubbles and securement of good close adhesion are preferably performed, and this is more preferred. There is an advantage that by press-bonding under vacuum, even in the case where fine gas bubbles remain, gas bubbles do not grow by heating and this is difficult to lead to distortion and defects.

It is preferred that when the inorganic layer-attached glass substrate 16 is peelably closely adhered to the glass substrate 18, surfaces at contacting sides of the inorganic layer 14 and the glass substrate 18 are sufficiently cleaned, and those are laminated in an environment having high cleanliness. The flatness becomes better as the cleanliness becomes high, and this is preferred.

The cleaning method is not particularly limited. For example, a method in which the surface of the inorganic layer 14 or the glass substrate 18 is cleaned with an alkali aqueous solution, and then further cleaned using water is exemplified.

The glass laminate 10 of the present invention can be used in various uses. For example, a use in the manufacturing of an electronic component such as a panel for a display device, PV, a thin film secondary battery or a semiconductor wafer having a circuit formed on the surface thereof as described hereinafter is exemplified. In this use, there are many cases that the glass laminate 10 is exposed (for example, 1 hour or longer) to high temperature conditions (for example, 350° C. or higher).

The panel for a display device used here includes LCD, OLED, electronic papers, plasma display panels, field emission panels, quantum dot LED panels, MEMS (Micro Electro Mechanical Systems) shutter panels, and the like.

### <Electronic Device and Manufacturing Method Thereof>

Next, preferred embodiments of the electronic device and manufacturing method thereof are described in detail.

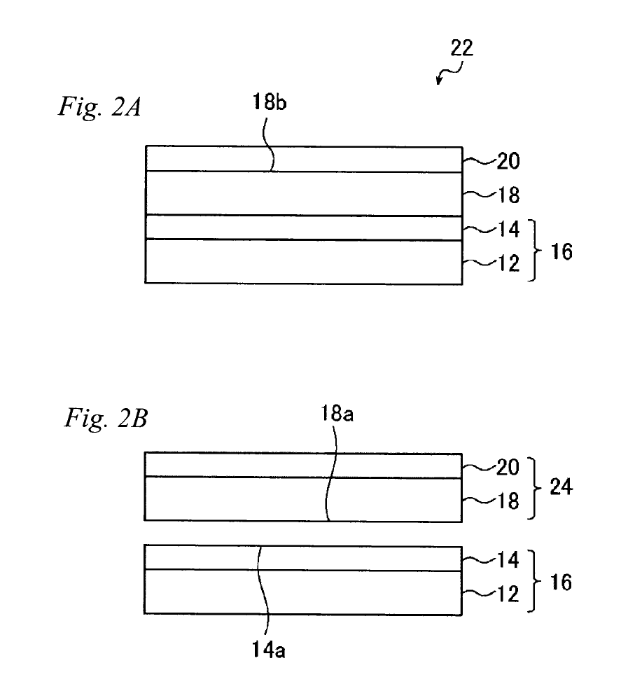

FIGS. 2A and 2B are schematically cross-sectional views showing each production step in order, in the preferred embodiment of the method for manufacturing an electronic device of the present invention. The preferred embodiment of the electronic device of the present invention includes a member formation step and a separation step.

Materials used in each step and its procedure are described in detail below by reference to FIGS. 2A and 2B.

### [Member Formation Step]

The member formation step is a step of forming an electronic device member on a glass substrate of a glass laminate.

More specifically, as shown in FIG. 2A, in this step, an electronic device member 20 is formed on the second main surface 18b of the glass substrate 18, and an electronic device member-attached laminate 22 is produced.

The electronic device member 20 used in this step is first described in detail, and the procedures of the subsequent steps are then described in detail.

### (Electronic Device Member (Functional Element))

The electronic device member 20 is a member for constituting at least a part of an electronic device, formed on the second main surface 18b of the glass substrate 18 in the glass laminate 10. More specifically, examples of the electronic device member 20 include a member used in an electronic component such as a panel for a display device, a solar cell, a thin film secondary battery or a semiconductor wafer having a circuit formed on the surface thereof. Examples of the panel for a display device include organic EL panels, plasma display panel, and field emission panels.

For example, examples of the member for a solar cell include a transparent electrode such as zinc oxide of a positive electrode, a silicon layer represented p layer/i layer/n layer, and a metal of a negative electrode, in a silicon type. Other than the above, the examples thereof can further include various members corresponding to a compound type, a dye sensitization type, a quantum dot type, and the like.

Furthermore, examples of the member for a thin film secondary battery include a transparent electrode of a metal or a metal oxide of a positive electrode or a negative electrode, a lithium compound of an electrolyte layer, a metal of a collection layer, and a resin as a sealing layer, in a lithium ion type. Other than the above, the examples thereof can further include various members corresponding to a nickel hydrogen type, a polymer type, ceramics electrolyte type, and the like.

Examples of the member for an electronic component include a metal of a conductive part, and silicon oxide and silicon nitride of an insulating part, in CCD and CMOS. The examples thereof can further include various sensors such as a pressure sensor or an acceleration sensor, and various members corresponding to a flexible printed circuit board, a rigid flexible printed circuit board, and the like.

### (Procedure of Step)

A manufacturing method of the electronic device member-attached laminate 22 described above is not particularly limited, and the electronic device member 20 is formed on the surface of the second main surface 18b of the glass substrate 18 in the glass laminate 10 by the conventional method according to the kind of a constructional member of an electronic device member.

The electronic device member 20 may not be the whole of the member finally formed on the second main surface 18b of the glass substrate 18 (hereinafter referred to as a “whole member”), but may be a part of the whole member (hereinafter referred to as a “partial member”). A partial member-attached glass substrate can be formed into a whole member-attached glass substrate (corresponding to an electronic device described hereinafter) by the subsequent steps. Furthermore, in the whole member-attached glass substrate, other electronic device member may be formed on its peeling surface (first main surface). Furthermore, an electronic device can be manufactured by fabricating a whole member-attached laminate and then peeling the inorganic layer-attached supporting substrate 16 from the whole member-attached laminate. Furthermore, an electronic device can be produced by fabricating an electronic device using two whole member-attached laminates and then peeling two inorganic layer-attached supporting substrates 16 from the whole member-attached laminates.

Taking the case of manufacturing OLED for example, in order to form an organic EL structure on the surface of the second main surface 18b of the glass substrate 18 in the glass laminate 10, various layer formations and treatments, such as forming a transparent electrode, further depositing a hole injection layer, a hole transport layer, a light emission layer, an electron transport layer and the like on the surface having the transparent electrode formed thereon, forming a back electrode, and sealing using a sealing plate, are conducted. Examples of those layer formations and treatments specifically include a film formation treatment, a deposition treatment and an adhesion treatment of a sealing plate.

Furthermore, for example, a manufacturing method of TFT-LCD has various steps such as a TFT formation step of forming a thin film transistor (TFT) on the second main surface 18b of the glass substrate 18 in the glass substrate 10 using a resist liquid by conducting pattern formation on a metal film, a metal oxide film and the like formed by a general film formation method such as a CVD method or a sputtering method, a CF formation step of forming a color filter (CF) on the second main surface 18b of the glass substrate 18 in another glass laminate 10 by using a resist liquid in pattern formation, and a bonding step of laminating a TFT-attached device substrate and a CF-attached device substrate.

In the TFT formation step and the CF formation step, TFT and CF are formed on the second main surface 18b of the glass substrate 18 using the conventional photolithography technology, etching technology or the like. In this case, a resist liquid is used as a coating liquid for pattern formation.

Prior to the formation of TFT and CF, the second main surface 18b of the glass substrate 18 may be cleaned as necessary. As the cleaning method, the conventional dry cleaning or wet cleaning can be used.

In the bonding step, a liquid crystal material is injected between the TFT-attached laminate and the CF-attached laminate, and lamination is then conducted. Examples of a method for injecting a liquid crystal material include a vacuum injection method and a dropping injection method.

### [Separation Step]

The separation step is a step of peeling the inorganic layer-attached supporting substrate 16 from the electronic device member-attached laminate 22 obtained by the member formation step described above to obtain an electronic device 24 comprising the electronic device member 20 and the glass substrate 18 (the electronic device member-attached glass substrate). That is, it is a step for separating the electronic device member-attached laminate 22 into the inorganic layer-attached supporting substrate 16 and the electronic device member-attached glass substrate 24.

In the case where the electronic device member 20 on the glass substrate 18 when peeling is a part of the formation of the entire constructional members, the remaining constructional members can be formed on the glass substrate 18 after separating.

A method for peeling (separating) the first main surface 14a of the inorganic layer 14 and the first main surface 18a of the glass substrate 18 is not particularly limited. For example, those surfaces can be peeled by inserting a sharp edged tool-like material in the interface between the inorganic layer 14 and the glass substrate 18 to give a trigger of peeling, and then blowing a mixed fluid of water and compressed air. Preferably, the electronic device member-attached laminate 22 is placed on a surface plate such that the supporting substrate 12 is an upper side and the electronic device member 20 is a lower side, the electronic device member 20 side is vacuum sucked on the surface plate (in the case that the supporting substrates are laminated on both surfaces, this operation is sequentially conducted), and an edged tool is inserted in the interface of the inorganic layer 14 and the glass substrate 18 in this state. Thereafter, the supporting substrate 12 side is sucked by a plurality of vacuum suction pads, and the vacuum suction pads are sequentially raised from the vicinity of the portion where the edged tool has been inserted. As a result, an air layer is formed in the interface between the inorganic layer 14 and the glass substrate 18, the air layer spreads over the entire surface of the interface, and the inorganic layer-attached supporting substrate 16 can be easily peeled.

The electronic device 24 obtained by the above steps is preferable in the manufacture of a small-sized display device to be used in a mobile terminal such as a mobile phone or PDA. The display device is mainly LCD or OLED, and the LCD includes TN type, STN type, FE type, TFT type, MIM type, IPS type and VA type. Basically, it can be applied to the case of any of display devices such as passive drive type and active drive type.

### EXAMPLES

The present invention is specifically described below by reference to examples and the like, but the invention is not construed as being limited to those examples.

In the following Examples and Comparative Examples, a glass plate comprising an alkali-free borosilicate glass (720 mm length×600 mm width×0.3 mm thickness, a linear expansion coefficient: 38×10⁻⁷/° C., trade name “AN 100”, manufactured by Asahi Glass Co., Ltd.) was used as the glass substrate. Furthermore, a glass plate comprising the same alkali-free borosilicate glass (720 mm length×600 mm width×0.4 mm thickness, a linear expansion coefficient: 38×10⁻⁷/° C., trade name “AN 100”, manufactured by Asahi Glass Co., Ltd.) was used as the supporting substrate.

### Example 1

One main surface of a supporting substrate was cleaned with pure water, and then cleaned with UV ray. Furthermore, a TiN (titanium nitride) layer (corresponding to an inorganic layer) having a thickness of 20 nm was formed on the cleaned surface by a magnetron sputtering method (heating temperature: 300° C., film formation pressure: 5 mTorr, and power density: 4.9 W/cm²) to obtain an inorganic layer-attached supporting substrate.

Next, one main surface of a glass substrate was cleaned with pure water, and then cleaned with UV ray. Cleaning by an alkali aqueous solution and cleaning by water were applied to an exposed surface of the inorganic layer of the inorganic layer-attached supporting substrate and the cleaned surface of the glass substrate, and the cleaned both surfaces were then bonded at room temperature by vacuum press to obtain a glass laminate A1.

In the glass laminate A1 obtained, the inorganic layer-attached supporting substrate and the glass substrate were closely adhered without generation of air bubbles, distortion-like defect was not observed, and smoothness was good.

Heat treatment was applied to the glass laminate A1 at 350° C. for 1 hour in an air atmosphere.

Next, a peeling test was conducted. Specifically, a second main surface of the glass substrate in the glass laminate A1 was first fixed to a fixing table, and the second main surface of the supporting substrate was sucked with a suction pad. Next, a knife having a thickness of 0.4 mm was inserted in the interface that is one of four corners of the glass laminate A1 and is between the inorganic layer and the glass substrate to slightly peel the glass substrate, thereby giving a trigger of peeling. Next, the suction pad was moved in a direction that leaves from the fixing table to peel the inorganic layer-attached supporting substrate and the glass substrate. Residue of the inorganic layer was not observed on the surface of the glass substrate peeled.

It was confirmed from the result that peel strength of the interface between the inorganic layer and a layer of the supporting substrate is larger than peel strength of the interface between the inorganic layer and the glass substrate.

### Example 2

A glass laminate A2 was produced according to the same procedure as in Example 1, except that an AlN (aluminum nitride) layer was prepared according to the following procedure, in place of formation of the TiN layer.

### (Preparation Procedure of AlN Layer)

One main surface of a supporting substrate was cleaned with pure water, and then cleaned with UV ray. Furthermore, an AlN layer (corresponding to an inorganic layer) having a thickness of 20 nm was formed on the cleaned surface by a magnetron sputtering method (heating temperature: 300° C., film formation pressure: 5 mTorr, and power density: 4.9 W/cm²) to obtain an inorganic layer-attached supporting substrate.

Peeling of the glass substrate was carried out in the same procedure as in Example 1, except that the glass laminate A2 was used in place of the glass substrate A1. As a result, the glass laminate A2 could be peeled (separated) into the inorganic layer-attached supporting substrate and the glass substrate. Residue of the inorganic layer was not observed on the surface of the glass substrate peeled.

### Example 3

A glass laminate A3 was produced according to the same procedure as in Example 1, except that a WSi (tungsten silicide) layer was prepared according to the following procedure, in place of formation of the TiN layer.

### (Preparation Procedure of WSi Layer)

One main surface of a supporting substrate was cleaned with pure water, and then cleaned with UV ray. Furthermore, a WSi layer (corresponding to an inorganic layer) having a thickness of 20 nm was formed on the cleaned surface by a magnetron sputtering method (room temperature, film formation pressure: 5 mTorr, and power density: 4.9 W/cm²) to obtain an inorganic layer-attached supporting substrate.

Peeling of the glass substrate was carried out in the same procedure as in Example 1 using the glass laminate A3 in place of the glass substrate A1. As a result, the glass laminate A3 could be peeled (separated) into the inorganic layer-attached supporting substrate and the glass substrate. Residue of the inorganic layer was not observed on the surface of the glass substrate peeled.

### Example 4

A glass laminate A4 was produced according to the same procedure as in Example 3, except that an inorganic thin film layer-attached glass substrate described hereinafter was used in place of the glass substrate. In the glass laminate A4, the inorganic layer comes into contact with the inorganic thin film layer.

### (Inorganic Thin Film Layer-Attached Glass Substrate)

One main surface of a glass substrate was cleaned with pure water, and then cleaned with UV ray. Furthermore, an ITO layer (corresponding to an inorganic layer) having a thickness of 150 nm was formed on the cleaned surface by a magnetron sputtering method (heating temperature: 300° C., film formation pressure: 5 mTorr, and power density: 4.9 W/cm²) to obtain an inorganic thin film layer-attached supporting substrate. Surface roughness Ra of the ITO layer was 0.85 nm.

Peeling of the glass substrate was carried out in the same procedure as in Example 1, except that the glass laminate A4 was used in place of the glass laminate A1 and the heating temperature was changed from 350° C. to 450° C. As a result, the glass laminate A4 could be peeled (separated) into the inorganic layer-attached supporting substrate and the inorganic thin film layer-attached glass substrate. Residue of the inorganic layer was not observed on the surface of the inorganic thin film layer-attached glass substrate peeled.

### Example 5

A glass laminate A5 was produced according to the same procedure as in Example 4, except that a SiC (silicon carbide) layer was prepared according to the following procedure, in place of formation of the WSi layer.

### (Preparation Procedure of SiC Layer)

One main surface of a supporting substrate was cleaned with pure water, and then cleaned with UV ray. Furthermore, a SiC layer (corresponding to an inorganic layer) having a thickness of 20 nm was formed on the cleaned surface by a magnetron sputtering method (room temperature, film formation pressure: 5 mTorr, and power density: 4.9 W/cm²) to obtain an inorganic layer-attached supporting substrate.

Peeling of the glass substrate was carried out in the same procedure as in Example 1 except that the glass laminate A5 was used in place of the glass laminate A1 and the heating temperature was changed from 350° C. to 600° C. As a result, the glass laminate A5 could be peeled (separated) into the inorganic layer-attached supporting substrate and the inorganic thin film layer-attached glass substrate. Residue of the inorganic layer was not observed on the surface of the inorganic thin film layer-attached glass substrate peeled.

### Example 6

A glass laminate A6 was produced according to the same procedure as in Example 1, except that a SiN (silicon nitride) layer was prepared according to the following procedure, in place of formation of the TiN layer.

### (Preparation Procedure of SiN Layer)

One main surface of a supporting substrate was cleaned with pure water, and then cleaned with UV ray. Furthermore, a SiN layer (corresponding to an inorganic layer) having a thickness of 20 nm was formed on the cleaned surface by a magnetron sputtering method (heating temperature: 300° C., film formation pressure: 5 mTorr, and power density: 4.9 W/cm²) to obtain an inorganic layer-attached supporting substrate.

Peeling of the glass substrate was carried out in the same procedure as in Example 1, except that the glass laminate A6 was used in place of the glass laminate A1 and the heating temperature was changed from 350° C. to 600° C. As a result, the glass laminate A6 could be peeled (separated) into the inorganic layer-attached supporting substrate and the glass substrate. Residue of the inorganic layer was not observed on the surface of the glass substrate peeled.

### Example 7

A glass laminate A7 was produced according to the same procedure as in Example 1, except that a SiC (silicon nitride) layer was prepared according to the following procedure, in place of formation of the TiN layer.

### (Preparation Procedure of SiC Layer)

One main surface of a supporting substrate was cleaned with pure water, and then cleaned with UV ray. Furthermore, a SiC layer (corresponding to an inorganic layer) having a thickness of 20 nm was formed on the cleaned surface by a magnetron sputtering method (room temperature, film formation pressure: 5 mTorr, and power density: 4.9 W/cm²) to obtain an inorganic layer-attached supporting substrate.

Peeling of the glass substrate was carried out in the same procedure as in Example 1, except that the glass laminate A7 was used in place of the glass laminate A1 and the heating temperature was changed from 350° C. to 600° C. As a result, the glass laminate A7 could be peeled (separated) into the inorganic layer-attached supporting substrate and the glass substrate. Residue of the inorganic layer was not observed on the surface of the glass substrate peeled.

### Comparative Example 1

One main surface of a supporting substrate was cleaned with pure water, and then cleaned with UV ray. Furthermore, an ITO layer (indium tin oxide layer) having a thickness of 150 nm was formed on the cleaned surface by a magnetron sputtering method (heating temperature: 300° C., film formation pressure: 5 mTorr, and power density: 4.9 W/cm²) to obtain an ITO layer-attached supporting substrate. Surface roughness Ra of the ITO layer was 0.85 nm.

Next, other main surface of the supporting substrate was cleaned with pure water, and then cleaned with UV ray. The cleaned surface of the glass substrate and an exposed surface of the ITO layer were subjected to cleaning with an alkali aqueous solution and cleaning with water. Thereafter, the cleaned both surfaces were bonded at room temperature by a vacuum press to obtain a glass laminate B1.

In the glass laminate B1 obtained, the ITO layer-attached supporting substrate and the glass substrate were closely adhered without generation of air bubbles, distortion-like defect was not observed, and smoothness was good.

Heat treatment was applied to the glass laminate B1 at 350° C. for 1 hour in an air atmosphere.

Next, according to the same procedure as in Example 1, a knife was inserted in the interface between the inorganic layer of the ITO layer-attached supporting substrate and the glass substrate to try to peel the glass substrate. However, the glass substrate could not be peeled.

The results of Examples 1 to 7 and Comparative Example 1 are shown in Table 1 below.

It was confirmed from the results of the peeling of the glass substrate that, in Examples 2 to 7, peel strength of the interface between the inorganic layer and the supporting substrate is larger than peel strength of the interface between the inorganic layer and the glass substrate, similar to Example 1.

In Table 1, the column of “Inorganic layer” shows a kind of an inorganic layer arranged (fixed) on a supporting substrate. The column of “Inorganic thin film layer” shows a kind of an inorganic thin film layer arranged (fixed) on a glass substrate. The column of “Heating temperature (° C.)” shows a temperature when heating a glass laminate. In the column of “Peelability evaluation”, the case that a glass substrate could be peeled from a supporting substrate after a heat treatment is indicated as “A” and the case that a glass substrate could not be peeled from a supporting substrate after a heat treatment is indicated as “B”.

TABLE 1

| | | | Heating | |
|---|---|---|---|---|
| | Inorganic | Inorganic thin | temperature | Peelability |
| | layer | film layer | (° C.) | evaluation |
| Example 1 | TiN | — | 350 | A |
| Example 2 | AlN | — | 350 | A |
| Example 3 | WSi | — | 350 | A |
| Example 4 | WSi | ITO | 450 | A |
| Example 5 | SiC | ITO | 600 | A |
| Example 6 | SiN | — | 600 | A |
| Example 7 | SiC | — | 600 | A |
| Comparative | ITO | — | 350 | B |
| Example 1 | | | | |

As shown in Table 1, in the glass laminates obtained in Examples 1 to 7, the glass substrate could be easily peeled even after the treatment under high temperature conditions.

Above all, it was confirmed from the comparison between Examples 3 and Example 4 that in the case of providing the inorganic thin film layer on the surface of the glass substrate, the glass substrate can be peeled even at higher temperature (450° C.).

Furthermore, it was confirmed from the comparison between Examples 1 and 2 and Examples 6 and 7 that in the case of using SiN or SiC as the inorganic layer, the glass substrate can be peeled even at higher temperature (600° C.).

On the other hand, in Comparative Example 1 in which ITO that is a metal oxide specifically used in Patent Document 1 was used, it was confirmed that the glass substrate cannot be peeled even in a heating condition of 350° C.

### Example 8

In this example, OLED was prepared using the glass laminate produced in Example 1.

More specifically, molybdenum was film-formed on the second main surface of the glass substrate in the glass laminate by a sputtering method, and a gate electrode was formed by etching using a photolithography method. Next, silicon nitride, intrinsic amorphous silicon and n-type amorphous silicon were film-formed in this order on the second main surface side of the glass substrate having the gate electrode provided thereon, by a plasma CVD method, and subsequently molybdenum was film-formed by a sputtering method, and a gate insulating film, a semiconductor element part and a source/drain electrode were formed by etching using a photolithography method. Next, silicon nitride was further film-formed on the second main surface side of the glass substrate by a plasma CVD method to form a passivation layer. Thereafter, indium tin oxide was film-formed by a sputtering method, and a pixel electrode was formed by etching using a photolithography method.

Subsequently, 4,4′,4″-tris(3-methylphenylphenylamino)triphenylamine as a hole injection layer, bis[(N-naphthyl)-N-phenyl]benzidine as a hole transport layer, a mixture of 8-quinolinol aluminum complex (Alq₃) and 40 vol % of 2,6-bis[4-[N-(4-methoxyphenyl)-N-phenyl]aminostyryl]naphthalene-1,5-dicarbonitrile (BSN-BCN) as a light emitting layer, and Alq₃ as an electron transport layer were further film-formed in this order on the second main surface side of the glass substrate by a deposition method. Next, aluminum was film-formed on the second main surface side of the glass substrate by a sputtering method, and a counter electrode was formed by etching using a photolithography method. Next, another glass substrate was bonded to the second main surface of the glass substrate having the counter electrode formed thereon, through a UV curable adhesive layer, followed by sealing. The glass laminate having the organic EL structure on the glass substrate, obtained by the above procedure corresponds to an electronic device member-attached laminate.

Subsequently, the sealing material side of the glass laminate obtained was vacuum sucked on a surface plate, an edged tool made of a stainless steel having a thickness of 0.1 mm was inserted in the interface between the inorganic layer of a corner part of the glass laminate and the glass substrate to separate the inorganic layer-attached supporting substrate from the glass laminate. Thus, an OLED panel (corresponding to an electronic device; hereinafter referred to as a “panel A”) was obtained. IC driver was connected to the panel A, and the panel was driven at ordinary temperature under ordinary pressure. As a result, uneven display was not observed in a driving region.

### Example 9

In this example, LCD was prepared using the glass laminate produced in Example 1.

Two glass laminates were prepared. Molybdenum was film-formed on a second main surface of a glass substrate of one glass laminate by a sputtering method, and a gate electrode was formed by etching using a photolithography method. Next, silicon nitride, intrinsic amorphous silicon and n-type amorphous silicon were further film-formed in this order on the second main surface side of the glass substrate having the gate electrode provided thereon, by a plasma CVD method, subsequently molybdenum was film-formed by a sputtering method, and a gate insulating film, a semiconductor element part and a source/drain electrode were formed by etching using a photolithography method. Next, silicon nitride was further film-formed on the second main surface side of the glass substrate by a plasma CVD method to form a passivation layer. Thereafter, indium tin oxide was film-formed by a sputtering method, and a pixel electrode was formed by etching using a photolithography method. Next, a polyimide resin liquid was applied to the second main surface of the glass substrate having the pixel electrode formed thereon, by a roll coating method, and an orientation layer was formed by heat curing, followed by rubbing. The glass laminate obtained is called a glass substrate X1.

Next, chromium was film-formed on a second main surface of a glass substrate in another glass laminate by a sputtering method, and a light shielding layer was formed by etching using a photolithography method. Next, a color resist was applied to the second main surface side of the glass substrate having the light shielding layer formed thereon, by a die coating method, and a color filter layer was formed by a photolithography method and heat curing. Next, indium tin oxide was further film-formed on the second main surface side of the glass substrate by a sputtering method, and a counter electrode was formed. Next, a UV curable resin liquid was applied to the second main surface of the glass substrate having the counter electrode formed thereon, by a die coating method, and a columnar spacer was formed by a photolithography method and heat curing. Next, a polyimide resin liquid was applied to the second main surface of the glass substrate having the columnar spacer formed thereon, by a roll coating method, and an orientation layer was formed by heat curing, followed by rubbing. Next, a sealing resin liquid was drawn in a frame shape on the second main surface side of the glass substrate by a dispenser method, a liquid crystal was added dropwise in the frame by a dispenser method, the second main surface sides of the glass substrates of the two glass laminates were bonded to each other using the glass laminate X1, and a laminate having an LCD panel was obtained by UV curing and heat curing. The laminate having an LCD panel is hereinafter called a panel-attached laminate X2.

Next, the inorganic layer-attached supporting substrates of both surfaces were peeled from the panel-attached laminate X2, similar to Example 1, and an LCD panel B (corresponding to an electronic device) comprising a substrate having a TFT array formed thereon and a substrate having a color filter formed thereon was obtained.

IC driver was connected to the LCD panel B prepared, and the LCD panel B was driven at ordinary temperature under an ordinary pressure. As a result, uneven display was not observed in a drive region.

This application is based on Japanese Patent Application No. 2012-122492 filed on May 29, 2012, the disclosure of which is incorporated herein by reference.

### DESCRIPTION OF REFERENCE NUMERALS AND SIGNS

10 Glass laminate
12 Supporting substrate
14 Inorganic layer
16 Inorganic layer-attached supporting substrate
18 Glass substrate
20 Electronic device member
22 Electronic device member-attached laminate
24 Electronic device (electronic device member-attached glass substrate)

1. A glass laminate comprising:
an inorganic layer-attached supporting substrate comprising a supporting substrate and an inorganic layer containing at least one kind selected from the group consisting of a metal silicide, a nitride, a carbide and a carbonitride, arranged on the supporting substrate; and
a glass substrate peelably laminated on the inorganic layer.

2. The glass laminate according to claim 1,
wherein the metal silicide contains at least one kind selected from the group consisting of W, Fe, Mn, Mg, Mo, Cr, Ru, Re, Co, Ni, Ta, Ti, Zr and Ba;
the nitride contains at least one element selected from the group consisting of Si, Hf, Zr, Ta, Ti, Nb, Na, Co, Al, Zn, Pb, Mg, Sn, In, B, Cr, Mo and Ba; and
the carbide and carbonitride contain at least one element selected from the group consisting of Ti, W, Si, Zr and Nb.

3. The glass laminate according to claim 1, wherein the inorganic layer contains at least one kind selected from the group consisting of tungsten silicide, aluminum nitride, titanium nitride, silicon nitride and silicon carbide.

4. The glass laminate according to claim 1, wherein the inorganic layer contains at least one kind selected from the group consisting of silicon nitride and silicon carbide.

5. The glass laminate according to claim 1, wherein the supporting substrate is a glass substrate.

6. The glass laminate according to claim 1, wherein the inorganic layer-attached supporting substrate and the glass substrate are peelable to each other even after heat-treating at 600° C. for 1 hour.

7. A method for manufacturing an electronic device, the method comprising:
a member formation step of forming an electronic device member on a surface of the glass substrate in the glass laminate according to claim 1 to obtain an electronic device member-attached laminate; and
a separation step of peeling the inorganic layer-attached supporting substrate from the electronic device member-attached laminate to obtain an electronic device having the glass substrate and the electronic device member.
